(19) United States
(12) Patent Application Publication
(10) Pub. No.: US 2013/0129495 A1
(43) Pub. Date: May 23, 2013

(54) HYDROELECTRIC TURBINE NOZZLES AND THEIR RELATIONSHIPS

(71) Applicants: Daniel Farb, Beit Shemesh (IL); Joe Van Zwaren, Beit Shemesh (IL); Avner Farkash, Beit Shemesh (IL); Ken Kolman, Beit Shemesh (IL)

(72) Inventors: Daniel Farb, Beit Shemesh (IL); Joe Van Zwaren, Beit Shemesh (IL); Avner Farkash, Beit Shemesh (IL); Ken Kolman, Beit Shemesh (IL)

(73) Assignee: LEVIATHAN ENERGY HYDROELECTRIC LTD., Beit Shemesh (IL)

(21) Appl. No.: 13/322,576

(22) PCT Filed: May 26, 2010
(86) PCT No.: PCT/IB10/52336

§ 371 Date: Mar. 28, 2012

Related U.S. Application Data
(60) Provisional application No. 61/244,083, filed on Sep. 21, 2009.
(60) Provisional application No. 61/180,949, filed on May 26, 2009.

(51) Int. Cl. F03B 1/00

(52) U.S. Cl. CPC F03B 1/00
USPC 415/201; 415/202; 29/890.01; 29/889.2

(57) ABSTRACT

Hydroelectric turbines in confined spaces depend heavily on nozzles and relationships involving nozzles and related turbine components in order to obtain maximal efficiencies for a wide range of flow conditions.

### FIELD AND BACKGROUND OF THE INVENTION

The present invention relates to the nozzle component of a hydroelectric turbine in a confined space. The problem of obtaining maximal efficiency from such a turbine is a difficult problem, which has been neglected due to the concentration on hydroelectric power from open systems that lead out into the air. In such systems, the choice of a nozzle is much simpler. In confined spaces and closed systems, there is a problem of jetting water through water and a problem of backpressure from the water, or other fluid. Therefore, different nozzle sizes and arrangements have a proportionately greater impact on efficiency in confined spaces.

### BRIEF DESCRIPTION OF THE DRAWINGS

The invention is herein described, by way of example only, with reference to the accompanying drawings, wherein:

FIG. 1 is a diagram of a CFD simulation of nozzle and blades.

FIG. 2 is a diagram of a CFD simulation with an irregular nozzle.

FIG. 3 is a diagram of a variety of nozzle orientations

FIG. 4 is a diagram of a nozzle with guide vanes.

FIG. 5 is a diagram of an on-center nozzle with an off-center turbine periphery.

FIG. 6 is a diagram of a nozzle used with an axial turbine.

FIG. 7 is a diagram of a nozzle replacement system.

### DESCRIPTION OF THE PREFERRED EMBODIMENTS

The present invention deals with the problem of increasing efficiency in hydroelectric turbines through the nozzle geometry and the relationships between the nozzles and other turbine components, with special attention to use in confined spaces such as a pipe.

Definitions: Any substance such as water, oil, or gas can be considered a fluid.

The principles and operation of a hydroelectric nozzle according to the present invention may be better understood with reference to the drawings and the accompanying description.

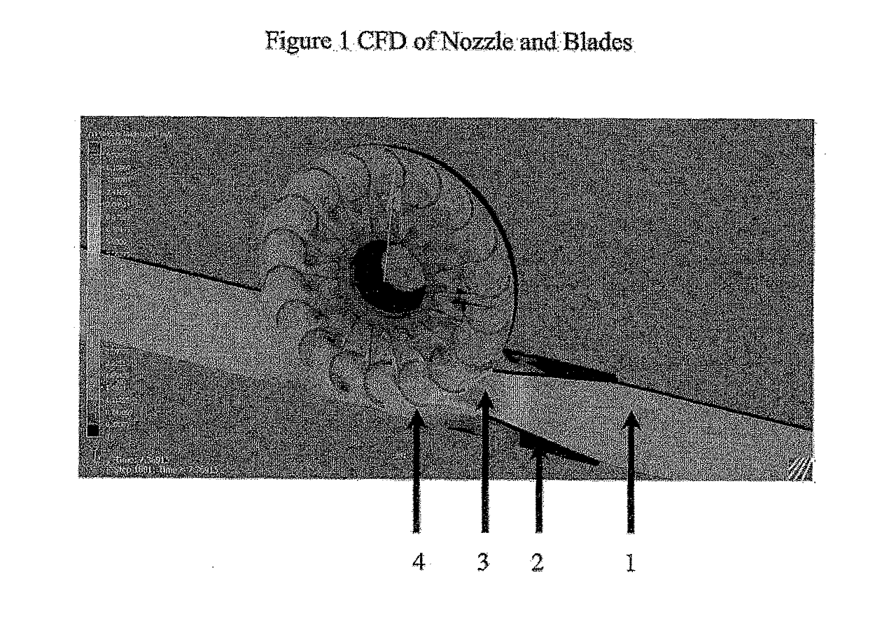

Referring now to the drawings, FIG. 1 illustrates a Computational Fluid Dynamics (CFD) simulation of water in a pipe (1) entering a turbine through a nozzle (2). The area (3) of greatest velocity produced by the effect of the nozzle is rapidly dissipated into a lower velocity stream in the area of the blades or cups (4). This diagram presents the unique challenge of dealing with environments for hydro turbines in which water jets through water onto the blades. An insufficient quantity of water rapidly loses its power, but confined flow is necessary to increase the velocity of fluid hitting the blades.

When a Pelton Turbine-like arrangement of cups absorbing the stream from the nozzle is used, as in FIG. 1, a tiny nozzle, as used in traditional hydro of water jetting through air, does not have the power to deliver water velocity to a cup the way that a larger nozzle does. So a larger nozzle is required.

Our simulations show that a 50 mm diameter nozzle for a 100 mm diameter pipe is substantially the best proportion, particularly in low pressure environments such as those below 5 atmospheres of pressure, and such a nozzle in association with a pipe with a variation of 5, 10, and then 15 mm in the nozzle diameter, and these amounts proportional to larger pipe sizes (nozzle diameter of 50%, 45-55%, 40-60%, and 35-65% of the pipe diameter), represent an innovative relationship.

We have performed numerous simulations of different nozzles and input conditions. A greater efficiency is noted for the 100 mm pipe size in association with an rpm of 90-150 for maximum power output in association with cup-like blades and low-pressure input. In addition, cups with a cross-sectional area of around 50% of the pipe size perform the best. Therefore the range of 45-55% and 40-60% of pipe cross-sectional area for the cross-sectional area of the blades, in association with nozzles of approximately 50% of pipe diameter, is an innovative concept, particularly in closed systems. In other embodiments, these are useful in association with specific blade shapes, such as a cone or a highly streamlined shape. These figures are for low-pressure differentials, up to around 5 atmospheres.

In most flow situations, the ideal ratio of the number of blades to the diameter of the nozzle in mm is 15 blades/50 millimeters with a range of plus/minus 3 blades, and more broadly as a range of plus/minus 6 blades in association with nozzles of around 50% of pipe diameter.

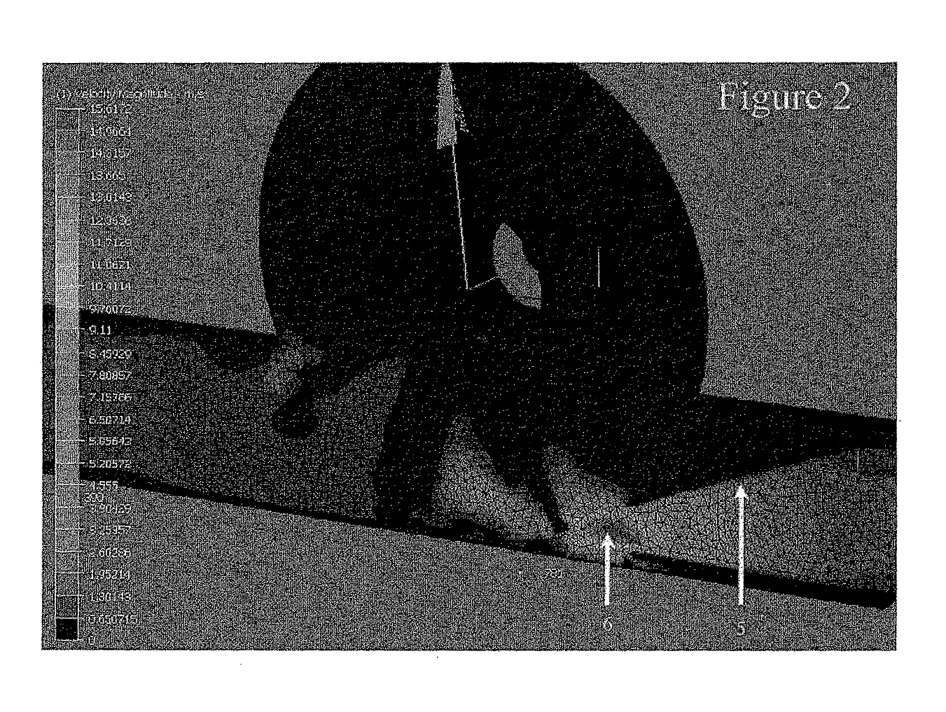

FIG. 2 is another CFD simulation that shows an irregular nozzle (5) with a high velocity area (6) that is smaller than that of a symmetrical nozzle as in FIG. 1.

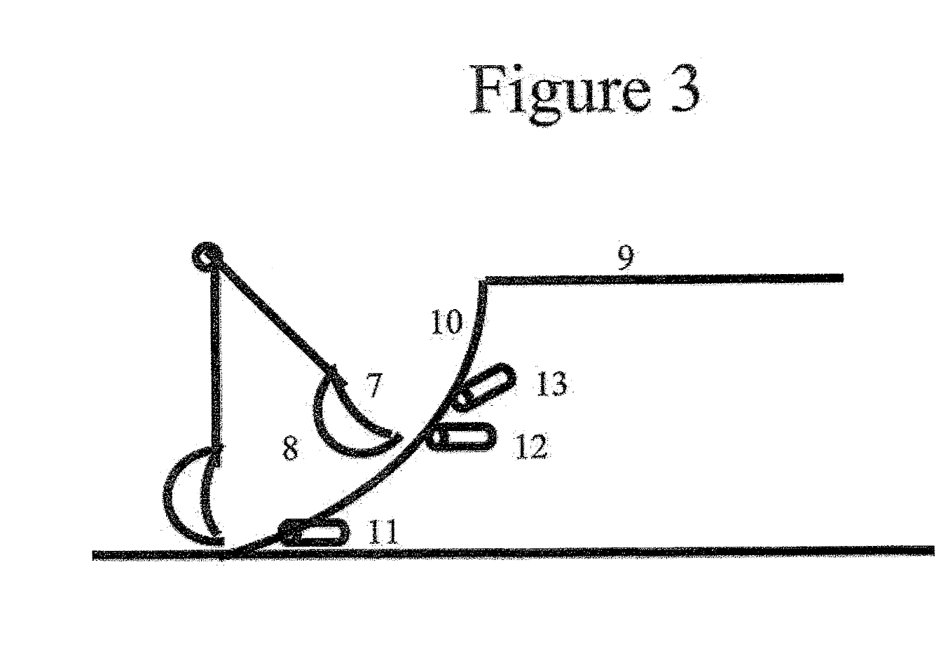

FIG. 3 illustrates some methods and devices to reduce the loss of energy from shooting a jet of fluid through fluid, in this embodiment, water. A pipe (9) is carrying water into a turbine. One concept is to make the nozzles come as close as possible to the blades at the best vector. A curved downstream end of the structure holding the nozzle, as in (10), enables closer apposition of the jet. The nozzle can also be held from a structure of different shape; the important part is the location of the nozzle itself. That enables a traditional nozzle arrangement, such as (12), to get closer. It is also possible to make the angle at which the jet hits the blade at an angle over 45 degrees, and even over 60 degrees, by coordinating the placement of the nozzles with the orientation of the blades. That results in a force along a more direct vector, as in (11) and (13).

In order to achieve a substantially exact decrease in pressure before and after an in-pipe turbine, the following factors are relevant: nozzle size, nozzle shape, shape of nozzle structure, pressure in, pressure out, angle of pipes, size of pipes, amount of head, flow rate, density of the fluid, rpm of the generator, number of cups on the blades, types of blades.

Since any nozzle causes some degree of backup, the construction of a system for generating electricity from the water flow to a specific destination, whereby a separate and parallel bypass starts from the point of substantially no backup, is the ideal way to construct such a turbine, and is hereby presented. The uniqueness of the system is the diversion from such a point.

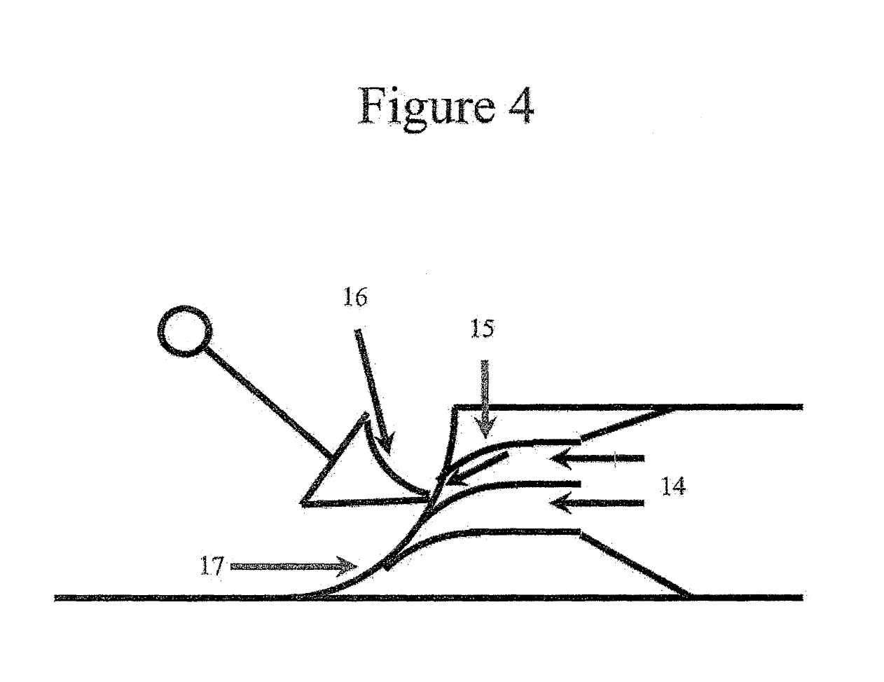

FIG. 4 is a diagram of a nozzle with guide vanes. This kind of nozzle may be used with cup or propeller types of blades. The nozzle (14) may in one embodiment divide into at least two sub-nozzles. Said nozzle or sub-nozzle can then form an angle of exit (15) different from a straight, forward direction. In the case of cups, the nozzle can be oriented to a straight line onto a blade's rear portion (16). The downstream edge of the nozzle structure may be either tapered around the perimeter of the cups, or in some other shape.

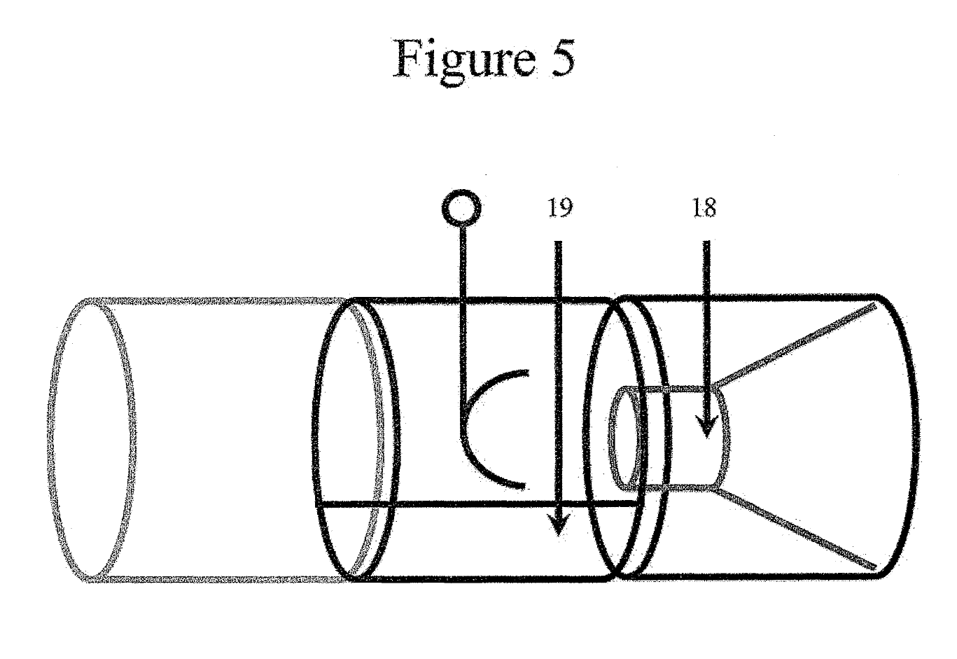

FIG. 5 is a diagram of an on-center nozzle with an off-center turbine periphery. The nozzle (18), while symmetrically in the middle from the upstream area, is directed to the outside periphery of the turbine space because the lower part of the pipe in the periphery of the turbine (19) is filled in. This enables increased velocity to hit the blades at the periphery. In one embodiment, the lower part of the pipe in the turbine chamber is blocked off.

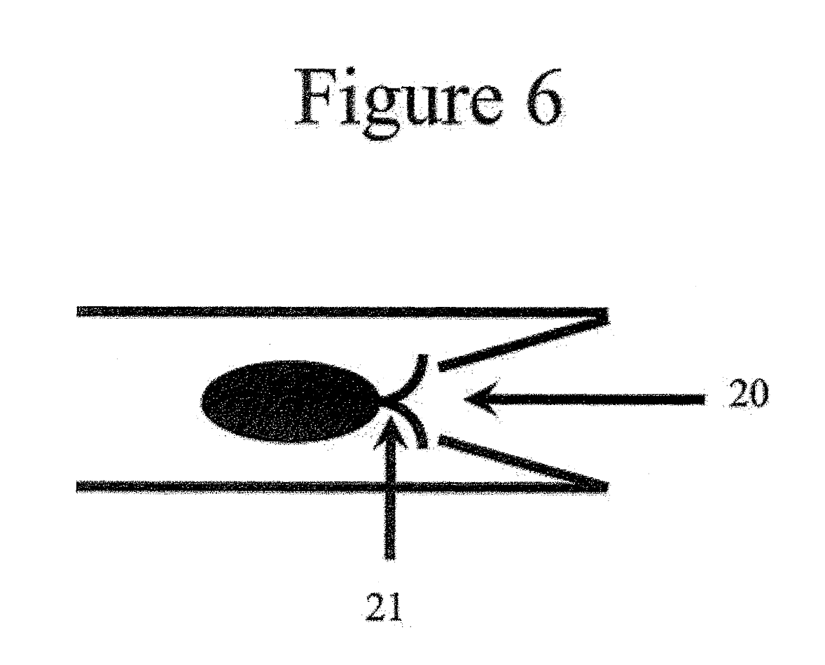

FIG. 6 is a diagram of a nozzle (20) used with an axial turbine (21). The advantage here is the lack of dissipation of the area of higher velocity flow by the rotating cups. This is different from prior art use of axial flow turbines, which may be associated with narrowing of the external pipe, but not with a nozzle structure causing narrowing within the pipe.

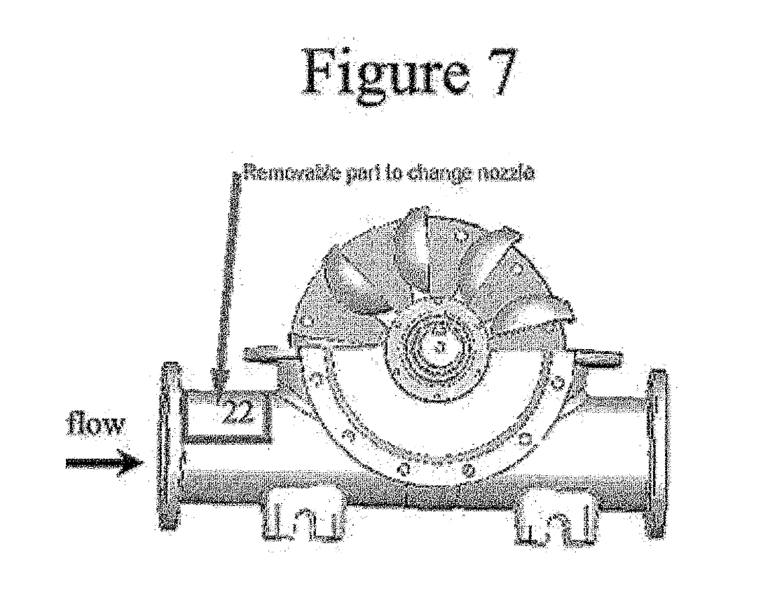

FIG. 7 is a diagram of a nozzle replacement system. This is intrinsically related to the other inventions, because the complex interactions among the in-pipe turbine components may require easy replacement of the nozzle to suit changing flow conditions, such as higher flows in the spring in an area of melting snow, especially since the nozzle is a crucial part of the adaptation to flow conditions. A latch (22) in the shell of the turbine in an upstream location from the turbine serves as the point from which to replace nozzles. Said latch can lock into place in any of many different ways.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a set of nozzles and relationships unique to in-pipe turbines.

It is now disclosed for the first time a method of manufacturing a nozzle for a hydroelectric turbine, comprising the steps of:

a. Providing a CFD simulation based on a minimum of the inputs of nozzle shape, nozzle size, nozzle position, shape and size of the blades and the turbine, flow rate of the fluid, revolutions per minute of the blades, and pipe size,
b. Providing a system substantially built according to the results of step a.

It is now disclosed for the first time a hydroelectric turbine in a pipe, comprising: a nozzle with at least one curved section in the shape of guide vanes.

In one embodiment, the system further comprises cup blades.

In one embodiment, the system further comprises propeller blades.

It is now disclosed for the first time a hydroelectric axial turbine in a pipe, comprising a nozzle.

According to another embodiment, the nozzle size is 45-55% of the cross-sectional area of the pipe.

It is now disclosed for the first time a hydroelectric turbine in a pipe, comprising:

a. A nozzle with a cross-sectional diameter of 45-55% of the pipe cross-sectional diameter.

In one embodiment, the system further comprises:

b. A blade system of less than 55% of the pipe cross-sectional diameter at its trailing end.

It is now disclosed for the first time a hydroelectric turbine in a pipe, comprising:

a. Cup-like blades,
b. Pipe size of 100 mm diameter,
c. Nozzle size of 40-60% of the pipe cross-sectional area,
d. Revolutions per minute of the turbine of 90-150,
e. Input pressure 5 bar or below.

According to another embodiment, the proportions for other circumstances are as follows: the said rpm is half of the above proportions for each doubling of the said pipe size, and the rpm is doubled for each halving of pipe size.

It is now disclosed for the first time a hydroelectric turbine in a pipe, comprising:

a. A nozzle size of 45-55% of pipe cross-sectional area,
b. A highly streamlined blade shape.
A highly streamlined blade has an angle from center point to the side of less than 45 degrees of the central line or curve from the front point.

It is now disclosed for the first time a hydroelectric turbine in a pipe, comprising:

a. A ratio of 15 cups per 50 millimeters of nozzle diameter, with a range of plus or minus 3 cups.

According to another embodiment, the range is plus or minus 6 cups.

It is now disclosed for the first time a hydroelectric turbine in a pipe, comprising nozzles and subnozzles.

It is now disclosed for the first time a hydroelectric turbine in a pipe, comprising:

a. A curved and tapered end of the structure holding the nozzle, facing the turbine,
b. A blade of cross-sectional area of less than 50% of the cross-sectional area of the pipe.

It is now disclosed for the first time a hydroelectric turbine in a pipe, comprising:

a. An on-center nozzle,
b. An off-center turbine with blades of cross-sectional area of less than 50% of the cross-sectional area of the pipe.

According to another embodiment, the unused off-center portion of the turbine section is blocked off.

It is now disclosed for the first time a hydroelectric turbine within a pipe, wherein the directionality of a nozzle in association with the orientation of the cross-section of the trailing edge of the blades is greater than 45 degrees.

According to another embodiment, the value is greater than 60 degrees.

It is now disclosed for the first time a hydroelectric turbine system in a pipe, comprising:

a. A nozzle,
b. A diversion around the area behind the nozzle, said diversion emanating from the pipe at a location before the presence of the nozzle causes a slowing of the fluid.

It is now disclosed for the first time a nozzle replacement system, comprising:

a. A hydroelectric turbine in a pipe,
b. A nozzle,
c. A latch on the shell in an upstream location for opening and closing the shell and inserting and removing nozzles,
d. A means for fastening and removing the nozzle to and from the turbine.

It is now disclosed for the first time a method of replacing a nozzle of different characteristics for different flow and pressure inputs for an in-pipe turbine.

It is now disclosed for the first time a method of providing a substantially exact decrease in pressure before and after an in-pipe turbine through entering at least the following inputs into a microprocessor: nozzle size, nozzle shape, nozzle orientation, shape of nozzle structure, pressure in, pressure out, angle of pipes, size of pipes, amount of head, flow rate, density of the fluid, rpm of the generator, number of cups on the blades, types of blades.

What is claimed is:

1-23. (canceled)

24. A hydroelectric turbine in a pipe, comprising:
a. A nozzle with a cross-sectional diameter of 45-55% of the pipe cross-sectional diameter.

25. The turbine of claim 24, further comprising:
a. At least one curved section in the shape of guide vanes in the nozzle.

26. The turbine of claim 25, further comprising:
b. Propeller blades.

27. The turbine of claim 24, further comprising:
b. A highly streamlined blade shape.

28. The turbine of claim 24, further comprising:
b. Blade cups in a ratio of 15 cups per 50 millimeters of nozzle diameter, with a range of plus or minus 6 cups.

29. The turbine of claim 24, comprising subnozzles from the main nozzle.

30. The turbine of claim 24, comprising:
b. Cup-like blades,
c. Pipe size of 100 mm diameter,
d. Revolutions per minute of the turbine of 90-150,
e. Input pressure 5 bar or below.

31. The turbine of claim 30, wherein the said rpm is half of the proportions of claim 30 for each doubling of the said pipe size, and the rpm is doubled for each halving of pipe size.

32. The turbine of claim 24, wherein the directionality of a nozzle in association with the orientation of the cross-section of the trailing edge of the blades is greater than 45 degrees.

33. The turbine of claim 24, further comprising,
b. A diversion around the area behind the nozzle, said diversion emanating from the pipe at a location before the presence of the nozzle causes a slowing of the fluid.

34. The turbine of claim 24, further comprising:
b. A latch on the shell in an upstream location for opening and closing the shell and inserting and removing nozzles,
c. A means for fastening and removing the nozzle to and from the turbine.

35. A method of manufacturing a nozzle for a hydroelectric turbine, comprising the steps of
a. Providing a CFD simulation based on a minimum of the inputs of nozzle shape, nozzle size, nozzle position, shape and size of the blades and the turbine, flow rate of the fluid, revolutions per minute of the blades, and pipe size,
b. Providing a system substantially built according to the results of step a.

36. A method of providing a substantially exact decrease in pressure before and after an in-pipe turbine through entering at least the following inputs into a microprocessor: nozzle size, nozzle shape, nozzle orientation, shape of nozzle structure, pressure in, pressure out, angle of pipes, size of pipes, amount of head, flow rate, density of the fluid, rpm of the generator, number of cups on the blades, types of blades.
